(19) United States
(12) Patent Application Publication
(10) Pub. No.: US 2010/0161631 A1
(43) Pub. Date: Jun. 24, 2010

(54) TECHNIQUES TO SHARE INFORMATION ABOUT TAGS AND DOCUMENTS ACROSS A COMPUTER NETWORK

(75) Inventors: Christopher C. Yu, Tokyo (JP); Shigeru Nakashita, Tokyo (JP); Makoto Fukuda, Kawasaki-City (JP); Hiromi Kobayashi, Tokyo (JP); Tsutomu Yanagida, Asao-ku (JP); Sander M. Viegers, Seattle, WA (US); Yong Woo Rhee, Seattle, WA (US); Venky Veeraraghavan, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/340,165

(22) Filed: Dec. 19, 2008

(51) Int. Cl. G06F 3/01; G06F 17/30

(52) U.S. Cl. 707/758; 715/751; 707/E17.014

(57) ABSTRACT

Technologies are described herein for providing an improved interface for interacting with a document within a private computer network. A computer program provides a person profile interface through a document viewer, the person profile interface enabling a user of a private computer network to select a different user of the private computer network, and present person profile tags and documents associated with the different user of the private computer network. The computer program further provides a tag profile interface through the document viewer, the tag profile interface enabling the user to select a tag, and present content tagged or commented on by other users of the private computer network and associated with the selected tag. Other embodiments are described and claimed.

### CROSS-REFERENCE TO RELATED APPLICATIONS

The present application is related to U.S. patent application Ser. No. 12/113,180, entitled “Sharing Information About A Document Across A Private Computer Network,” filed on Apr. 30, 2008, assigned to the same assignee as the present application and expressly incorporated herein by reference.

### BACKGROUND

As organizations have become more and more dependent upon computers, intranets and other private computer networks have been developed to internally manage and share information within the organization. An intranet is a network that is typically restricted to specific users, such as employees of an organization, and access to the intranet generally requires some form of authentication, such as a username and password. An intranet may provide access to internal files, emails, and other information stored on an enterprise server. The intranet may also be connected to other networks (e.g., the Internet) to provide access to public content that is not restricted to the users of the intranet.

In a standard implementation, an intranet is embodied in a variety of web pages. In this way, the users can access the intranet using a standard web browser. From a user's standpoint, since web browsers are already commonly used to access the Internet, the learning curve is relatively low for operating the same or a similar web browser to access the intranet. From a developer's standpoint, intranet website development is similar to Internet website development, and the development of Internet-based web pages is well-established. For example, intranet websites may also be developed using HyperText Markup Language (“HTML”), scripting languages such as JAVASCRIPT from SUN MICROSYSTEMS INC. and VIRTUAL BASIC SCRIPTING EDITION (“VBSCRIPT”) from MICROSOFT COPORATION, and other suitable development tools for creating Internet websites. It should be noted that the intranet may also enable access to a variety of other documents besides web pages, such as word processing documents, spreadsheet documents, presentation documents, and the like. Access to these documents may be provided by the web browser or other suitable document viewer.

Despite the increasing availability of shared information across a private computer network, users may have difficulties in accessing the shared information. This is because in part that the search and interface tools implemented for private computer networks mimic or replicate the search and interface tools typically used for public computer networks. This occurs even though an intranet typically shares information in a manner typical of semi-public computer networks, such as social networks that require some form of registration, login and trust procedures to share information. Furthermore, it may be difficult to find users that share common interests, or that are working on similar topics. Consequently, improvements in search and interface tools for private computer networks may enhance information sharing between users of the private computer networks.

### SUMMARY

Technologies are described herein for providing an improved user interface for interacting with documents and sharing information about the documents with other users across an intranet or other private computer network. In particular, through the utilization of the technologies and concepts presented herein, a user can access an interface provided within a document viewer and utilize the interface to interact with the document. For example, the document viewer may be a web browser for viewing web pages, a word processing application for viewing text documents, a spreadsheet application for viewing spreadsheet documents, a presentation application for viewing presentation documents, or other suitable client-side document viewer. In one embodiment, the interface is provided within a document, such as within intranet web page, an Internet web page, or word processing document. In another embodiment, the interface may be provided by a document viewer, such as a standard web browser or a word processing software application. For example, the interface may be provided by the document viewer upon installing a plug-in or other suitable method.

It is worthy to note that various embodiments can be used for both private computer networks, such as an intranet for an organization, a for public computer networks having characteristics of a private computer network. An example of the latter case may include various public computer networks, such as an Internet site, having a non-anonymous and registered set of users. For instance, a public Internet site may host a neighborhood book club where registered members of the club tag their favorite selections on other publically available websites (e.g., book sellers, blogs, etc.) and assembles the favorite books per club member). The embodiments are not limited in this context.

According to embodiments, an improved interface may be provided within a document viewer. As used herein, a document viewer may include a web browser or other suitable client-side document viewer capable of accessing one or more types of documents (e.g., word processing documents, spreadsheet documents, presentation documents, etc.). The improved interface may enable a user to access profile pages for each tag applied to documents and websites across a private computer network. The profile page may be similar in concept and implementation as profile pages typically associated with individuals. In this case, the concept of a personal profile page for an individual has been extended to a tag. Each profile page may contain a discussion area and a listing of experts and people interested in the topic, among other information about the tag. A tag may comprise any user defined metadata attached to content to aid in the discovery or recall of the content.

The improved interface may further enable documents tagged with a particular term to be coalesced into single pages. This may allow various subjects to be managed via a managed or unmanaged taxonomy. The improved interface may also enable interactive tag operations to provide a richer query experience so that users can see related tags and use them to create a more specific query. The improved interface may still further create web pages for users that contain documents they have previously tagged and for which they have previously provided comments. The improved interface may also provide a news feed on each tag or topic that shows recent activities. These and other features of the embodiments may allow users greater access to information shared on a private computer network, therefore enhancing productivity and social networking aspects of the private computer network.

According to one aspect presented herein, a computer program provides a person profile interface through a document viewer, the person profile interface enabling a user of a private computer network to select a different user of the private computer network, and present person profile tags and documents associated with the different user of the private computer network. The computer program further provides a tag profile interface through the document viewer, the tag profile interface enabling the user to select a tag, and present content tagged or commented on by other users of the private computer network and associated with the selected tag. The embodiments are not limited in this context.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates one embodiment of a network architecture diagram.

FIG. 2 illustrates one embodiment of a first social interface.

FIG. 3 illustrates one embodiment of a first interface view.

FIG. 4 illustrates one embodiment of a second social interface.

FIG. 5 illustrates one embodiment of a second interface view.

FIG. 6 illustrates one embodiment of a flow diagram.

FIG. 7 illustrates one embodiment of a computer architecture diagram.

### DETAILED DESCRIPTION

The following detailed description is directed to technologies for interacting with documents and sharing information about the documents with other users across an intranet or other private computer network. Through the utilization of the technologies and concepts presented herein, a user can access an interface provided within a document viewer and utilize the interface to interact with the document. For example, the document viewer may be a web browser for viewing web pages, a word processing application for viewing text documents, or other suitable document viewer. In one embodiment, the interface is provided within a document, such as within intranet web page, an Internet web page, or a word processing document. In another embodiment, the interface may be provided by a document viewer, such as a standard web browser or a word processing software application. For example, the interface may be provided by the document viewer upon installing a plug-in or other suitable method.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

For purposes of illustration, the embodiments described herein primarily refer to a web browser as an exemplary implementation of a document viewer, and a web page as an exemplary implementation of a document. The web browser may be configured to view private web pages over an intranet as well as publicly-accessible web pages over the Internet. Other client-side document viewers, such as word processing applications, spreadsheet applications, presentation applications, and the like, may be similarly utilized. Documents may include, but are not limited to, web pages, text documents, spreadsheet documents, and presentation documents. Examples of client-side document viewers for viewing word processing applications include WORD from MICROSOFT® CORPORATION, PAGES from APPLE® INC., and LOTUS WORD PRO from INTERNATIONAL BUSINESS MACHINES® CORPORATION. Examples of client-side document viewers for viewing spreadsheet applications include EXCEL® from MICROSOFT CORPORATION and NUMBERS from APPLE INC. Examples of client-side document viewers for viewing presentation documents include POWERPOINT® from MICROSOFT CORPORATION and KEYNOTE® from APPLE INC.

Standard web browsers generally do not provide functionality for aggregating information shared across a private computer network. In particular, standard web browsers do not provide functionality for aggregating information sharing a tag, or users creating and implementing tags for documents. This functionality generally allows a user to tag and comment on documents, which can then be subsequently searched by the tag. Searching for specific documents having a particular tag, however, fails to fully exploit the trust capabilities provided by a private computer network. For instance, private computer networks typically implement managed or unmanaged taxonomies. Consequently, tag-centric functionality may be leveraged from the managed or unmanaged taxonomies. In another example, private computer networks typically store information about users of the private computer networks, as well as their use habits. As a result, person-centric functionality may be leveraged using this stored information.

Embodiments described herein provide a user interface that enables a user to select and view shared information across a private computer network. This interface is referred to herein as a social interface. In one embodiment, the social interface is provided as part of a web page. In particular, the web page may be altered or manipulated in any suitable manner to incorporate the social interface. For example, the social interface may be placed in a hypertext markup language (“HTML”) frame. In another embodiment, the social interface is provided by a web browser. For example, a browser plug-in may be installed on a standard web browser to add the social interface to the web browser.

It should be appreciated that in some embodiments, the social interface is provided independently of web page content, so even existing web pages can be displayed without any changes in design. In particular, the enhanced interface functionality provided by the social interface may be implemented and managed via an intranet web server software application or other suitable private computer network software application executing on a central server.

In the following detailed description, references are made to the accompanying drawings that form a part hereof, and which are shown by way of illustration, specific embodiments, or examples. Referring now to the drawings, in which like numerals represent like elements through the several figures, aspects of a computing system and methodology for providing an improved user interface for interacting with web pages and sharing information about the web pages with other users across a private computer network will be described.

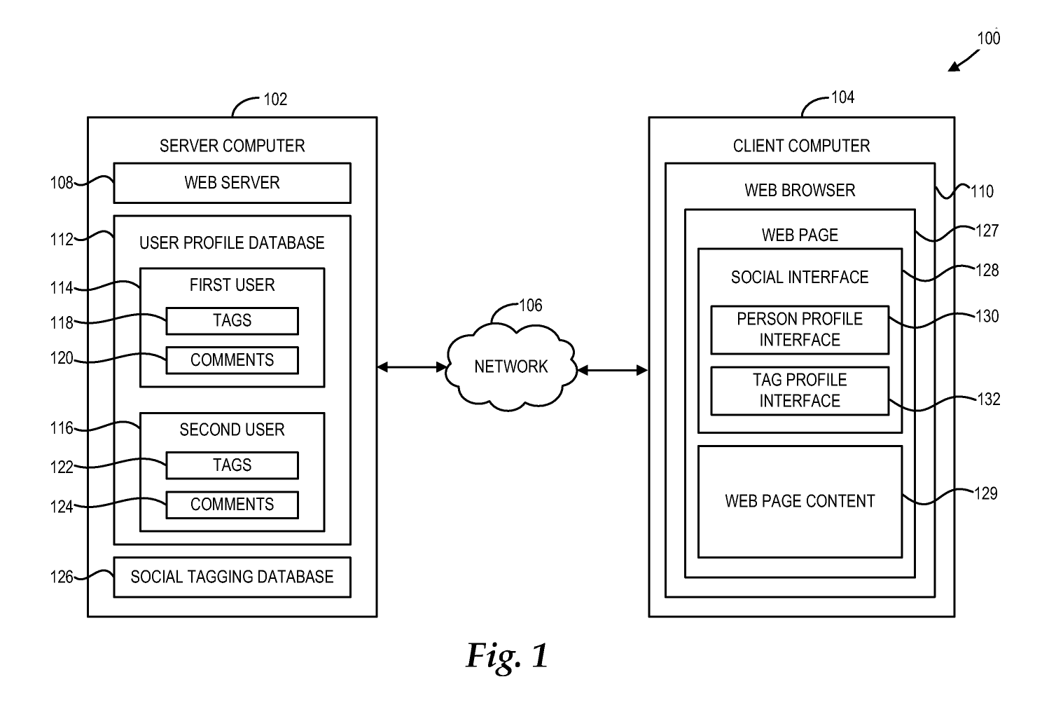

FIG. 1 illustrates a private computer network 100 suitable for implementing various embodiments of a social interface adapted to enable a user to select, view and interact with information provided by users of the private computer network 100. In particular, FIG. 1 shows aspects of the private computer network 100 including a server computer 102 and a client computer 104 operatively connected via a network 106. In one embodiment, the server computer 102 is an enterprise server and the network 106 is a private computer network, such as an intranet. As used herein, a private computer network refers to a computer network which restricts access to only a limited number of users. The network 106 may be any suitable private computer network as contemplated by those skilled in the art. The network 106 may also be operatively connected to other suitable networks, such as the Internet. In this way, the private computer network may be used to access documents and other content stored within the private computer network, as well as publicly-accessible documents and content that are outside the private computer network.

In one embodiment, the server computer 102 is a standard computer system capable of executing an operating system and one or more application programs. In particular, the server computer 102 executes a web server application (hereinafter “web server”) 108, which enables the client computer 104 to access the server computer 102 via a web browser application (hereinafter “web browser”) 110. The web server 108 may also perform an authorization function (e.g., by requesting a username and password) in order to verify that a given user of the client computer 104 is authorized to access the server computer 102.

The web server 108 may be configured to accept data requests from the client computer 104 to the server computer 102, and to transmit data responses from the server computer 102 to the client computer 104. These data requests and responses may be transmitted via any suitable protocol, such as hypertext transfer protocol (“HTTP”), file transfer protocol (“FTP”), real-time streaming protocol (“RTSP”), hypertext transfer protocol over secure socket layer (“HTTPS”), and the like. In one embodiment, the web server 108 is an intranet web server. In other embodiments, the web server 108 may be any suitable web server.

The server computer 102 further includes a user profile database 112, which includes data storage associated with multiple users, and a social tagging database 126 for storing tags created by the multiple users. In particular, FIG. 1 illustrates a first user storage 114 for storing content associated with a first user and a second user storage 116 for storing content associated with a second user. The first user storage 114 includes a first tag storage 118 for storing tags associated with the first user and a first comment storage 120 for storing comments associated with the first user. Similarly, the second user storage 116 includes a second tag storage 122 for storing tags associated with the second user and a second comment storage 124 for storing comments associated with the second user. The social tagging database 126 may also store tags associated with the users who specified the tags. It should be appreciated that the user profile database 112 and the social tagging database 126 may be combined into a single database. Further, the information contained in the user profile database 112 and the social tagging database 126 may be divided into other database configurations, as contemplated by those skilled in the art. Additional details regarding the implementation and applicability of tags, tags, and comments will be provided below.

In one embodiment, the client computer 104 is a standard desktop or laptop computer system capable of executing an operating system and one or more application programs. It should be appreciated, however, that in other embodiments the client computer 104 may be another type of computing device. For instance, according to embodiments, the client computer 104 may be a mobile computing device, such as a mobile telephone, a smartphone, an ultra-mobile personal computer, a tablet personal computer, or other suitable mobile computing device. Other devices may also be utilized in a similar manner.

According to embodiments, the client computer 104 is operative to execute a web browser 110 and other suitable applications. The web browser 110 may be any standard web browser adapted to access a variety of content, including web pages, over the network 106. In particular, the web browser 110 may be adapted to view intranet-based web pages provided by the server computer 102, as well as Internet-based web pages provided by over the Internet. The web browser 110 may access the content via any suitable transmission protocols, such as HTTP, FTP, RTSP, HTTPS, and the like.

As illustrated in FIG. 1, the web browser 110 is configured to display a web page 127, which includes a social interface 128 and web page content 129. For example, the web page content 129 may be an existing web page or other web-based content apart from the social interface 128. As shown in FIG. 1, the social interface 128 includes, among other types of interfaces, a person profile interface 130 and a tag profile interface 132. The social interface 128 may display information stored by the user profile database 112 and/or social tagging database 126 as served by the web server 108. The social interface 128 may also accept input information via one or more input elements, such as a dialog box or other suitable interface element. The social interface 128 may also include other suitable interfaces for social networking, such as a tagging interface designed to tag documents, a comment interface designed to provide comments about a document, a communication interface designed to communicate information with other users of the private computer network 100, and so forth.

In one embodiment, the social interface 128 and the web page content 129 may be combined in a single HTML frame. In other embodiments, the social interface 128 may be provided in one HTML frame, while the web page content 129 is provided in another HTML frame. Other suitable methods for partitioning the social interface 128 and the web page content 129 may be similarly utilized. In another example, the social interface 128 may be included in a toolbar or other part of the web browser 110. In one embodiment, the social interface 128 is provided thorough a drop-down or pop-up window. In this way, the social interface 128 can be hidden until a user selects a social button or other suitable interface element. The social button may be sized and presented in a non-interfering manner on existing web pages (e.g., displayed on a corner of a web page). Other ways for providing the social interface 128 through the web browser 110 may be similarly utilized.

Upon accessing the social interface 128, a user may utilize the person profile interface 130 and the tag profile interface 132 to display documents accessible via the network 106. The documents may have one or more tags associated with the documents by a user. The tags generated by a given user may be stored on the user profile database 112 of the server computer 102. For example, the tags associated with a first user may be stored in the first tag storage 118, and the tags associated with a second user may be stored in the second tag storage 122.

In one embodiment, a user may generate a person profile document through a document viewer using the person profile interface 130. The person profile document may comprise, for example, a web page having web content associated with a user, such as the first and second users. The document viewer may comprise, for example, the web browser 110 or some other suitable document viewing tool. The person profile interface 130 may enable a user of the private computer network 100 to select a person profile associated with the user or a different user of the private computer network 100. The person profile interface 130 may generate a person profile document for the selected person, and present person profile tags and documents associated with the user or the different user of the private computer network 100.

In one embodiment, a user may generate a tag profile document through a document viewer using the tag profile interface 132. The tag profile document may comprise, for example, a web page having web content associated with a tag, such as the tags stored by the social tagging database 126. The document viewer may comprise, for example, the web browser 110 or some other suitable document viewing tool. The tag profile interface 132 may enable a user of the private computer network 100 to select a tag profile associated with a tag stored by the social tagging database 126. The tag may comprise, for example, an arbitrary tag created by a user. The tag may also comprise, for example, a managed tag created by an organization and selected by the user, such as a managed tag comprising part of a managed taxonomy for the private computer network 100. The tag profile interface 132 may enable a user to select a tag, and present content tagged or commented on by the user or other users of the private computer network 100 and associated with the selected tag.

As used herein a comment refers to a communication made by the user with regards to a web page or other document. A user may provide multiple comments for a single web page, and multiple users may each provide comments for a single web page. Further, a single user may provide comments for multiple web pages. The comments may be stored on the user profile database 112 of the server computer 102. For example, the comments associated with the first user may be stored in the first comment storage 120, and the comments associated with the second user may be stored in the second comment storage 124. Additionally or alternatively, the tags and/or comments may be stored in the social tagging database 126 and referenced from the user profiles. The embodiments are not limited in this context.

In one embodiment, a user may generate comments via any suitable comment interface internal or external to the social interface 128. The comment interface may include a suitable interface element enabling a user to comment on a given web page. For example, the comment interface may include a text entry box for entering comments. Once a user enters comments via the text entry box, the comment interface may display the user's comments along with comments from other users. Each comment displayed in the comment interface may display, among other information, the name of the user who made the comment, the date in which the comment was made, and/or the time in which the comment was made. In this way, a user may view comments made by other users and even create a conversation with the other users within the comment interface.

As used herein, a tag refers to a designation associating a keyword, which contains one or more words, to a given web page. The keyword may include arbitrary keywords generated by users and/or managed keywords generated by the organization operating the server computer 102 or another entity. The managed keywords may include commonly used keywords, trademarks, and trade names. The managed keywords and taxonomy terms are usually organizationally defined elements where consistency is desired. For example, a law firm could specify in their taxonomy their practices areas, clients, cases, etc. In other words, it can be quite specific or arbitrary depending on the needs of the organization defining the terms. Providing managed keywords may prevent misspellings or multiple spellings or versions of certain keywords entered by users. The tags and corresponding keywords may be stored in the social tagging database 126 of the server computer 102. In one embodiment, the keywords provide a way for users to search for and browse web pages. In particular, a suitable search engine (not shown) may be operatively coupled to the social tagging database 126 to search for web pages based on keywords. Popular keywords may also be easily determined by searching for keywords associated with a larger number of tags.

In one embodiment, a user may associate a keyword with a web page via a suitable tagging interface. The tagging interface may include a suitable interface element enabling a user to create a keyword and/or select a keyword from a list of managed keywords and other previously-generated keywords. Also, a suggested keyword may be provided to the user as the user enters the keyword into the tagging interface. For example, the tagging interface may include a text entry box configured with an autocomplete feature that predicts the keyword as the user enters characters into the text entry box. The autocomplete feature may complete a partially entered keyword with the full keyword. The autocomplete feature may also replace entered characters with a keyword. For example, the autocomplete feature may replace an abbreviation with the keyword associated with the abbreviation.

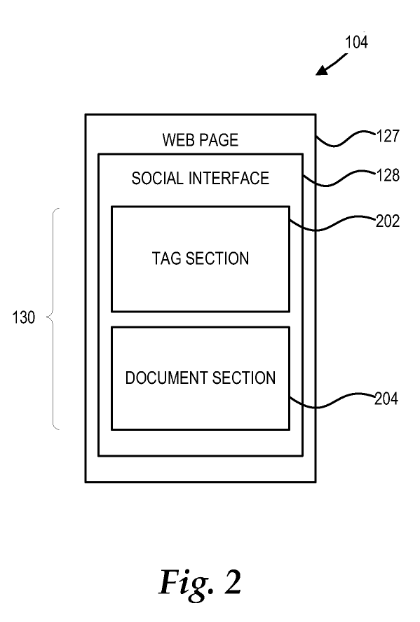

FIG. 2 illustrates a more detailed block diagram for the social interface 128. In the illustrated embodiment shown in FIG. 2, the web page 127 may provide the social interface 128 with the person profile interface 130. The person profile interface 130 may generally create a person profile document for display as the web page 127 by the web browser 110 on a display. In one embodiment, the person profile interface 130 may generate a person profile document having a tag section 202 and a document section 204. The person profile interface 130 may retrieve information for the tag section 202 and/or the document section 204 from the user profile database 112 and/or the social tagging database 126. Real-time searches across the private computer network 100 may also be used as well.

In one embodiment, the person profile interface 130 may comprise the tag section 202 arranged to present person profile tags for a user. The tag section 202 may present person profile tags previously used or tracked by a user, and associated metadata for the person profile tags. The person profile tags may represent a list of tags that are somehow relevant or of interest to a user. In this manner, a user of the private computer network 100 may view a list of tags that are relevant or of interest to another user of the private computer network 100 by selecting a hyperlink to the person profile of the other user, and determine therefrom whether there is any common social interest to begin social networking activities with the user.

In one embodiment, the person profile interface 130 may comprise the document section 204 arranged to present documents having been previously tagged or commented on by a user, and associated metadata for the documents. In this manner, a user of the private computer network 100 may view what content another person is reading and recommending to others for reading, and to the extent there is overlapping interest for a person profile tag between users, lead the user to the same or similar content provided by the document section 204.

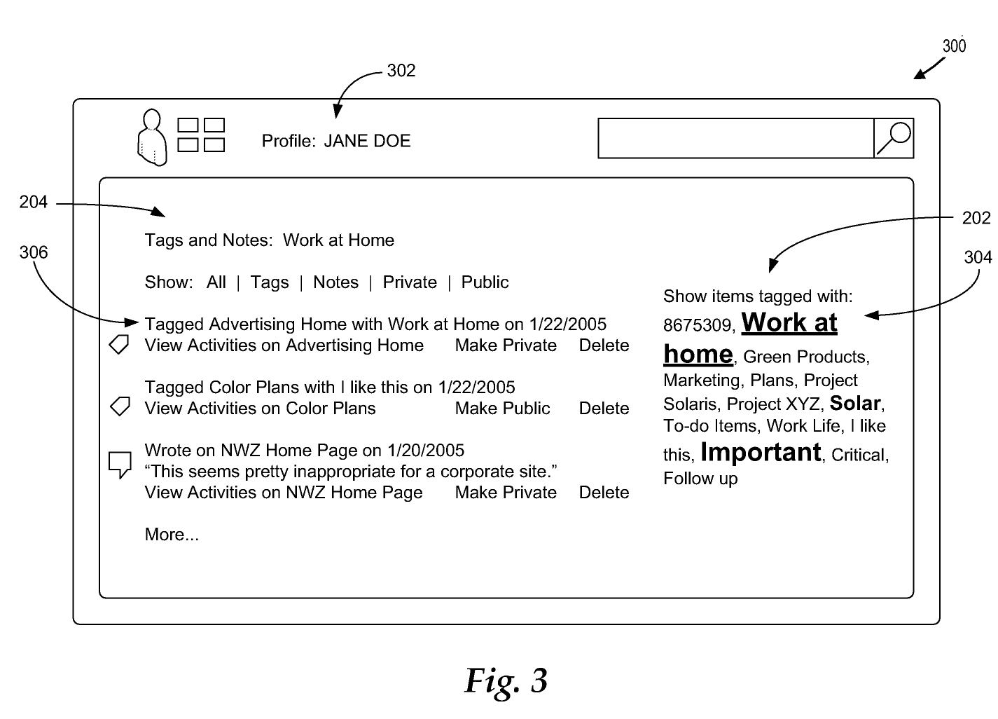

FIG. 3 is a screen display diagram showing an illustrative screen display 300 provided by the web browser 110 in various embodiments presented herein. In particular, FIG. 3 shows an illustrative implementation of the person profile interface 130 of the social interface 128. It should be appreciated that other interface elements may be utilized to represent the social interface 128 as contemplated by those skilled in the art.

In the illustrated embodiment shown in FIG. 3, the screen display 300 illustrates an exemplary implementation of a web page 127 including a person profile interface 130 for a user 302 named “Jane Doe.” The person profile interface 130 may present a tag section 202 titled “Show items tagged with” and a list of person profile tags, such as “Work at home,” “Green Products,” “Important” and so forth. The tag section 202 may display the person profile tags as a tag cloud, with some of the person profile tags having different visual effects to enhance viewing of the person profile tags (e.g., bold, underline, font size, and other text effects). The person profile interface 130 may also present a document section 204 titled “Tags and Notes.” The document section 204 may present a list of documents tagged with one or more of the person profile tags shown in the tag section 202, or commented on by the user Jane Doe.

In general operation, assume a user John Smith notices that the user 302 Jane Doe seems to have similar interests. The user John Smith may utilize the person profile interface 130 to select a person profile document for the user Jane Doe, which generates the screen display 300. The screen display 300 lists the person profile tags that have been used or monitored by Jane Doe in the tag section 202. The list of person profile tags may be ordered in any manner, such as frequency of use, user-configured priority, popularity, and so forth. The document section 204 may automatically display a list of documents tagged with some or all of the person profile tags shown in the tag section 202. The list of tagged documents may be ordered in any manner, such as most recently tagged/commented to least recently tagged/commented, number of person profile tags for each document, and so forth.

After perusing the list of person profile tags for Jane Doe, assume the user John Smith selects the person profile tag 304 titled “Work at home.” The person profile interface 130 may automatically generate a list of documents tagged with the tag 304 titled “Work at home,” and the screen display 300 displays the tagged documents in the document section 204, such as the representative tagged document 306 titled “Tagged Advertising Home with Work at Home on 1/22/2005.” The list of tagged documents presented in the document section 204 may dynamically change as different person profile tags are selected from the tag section 202.

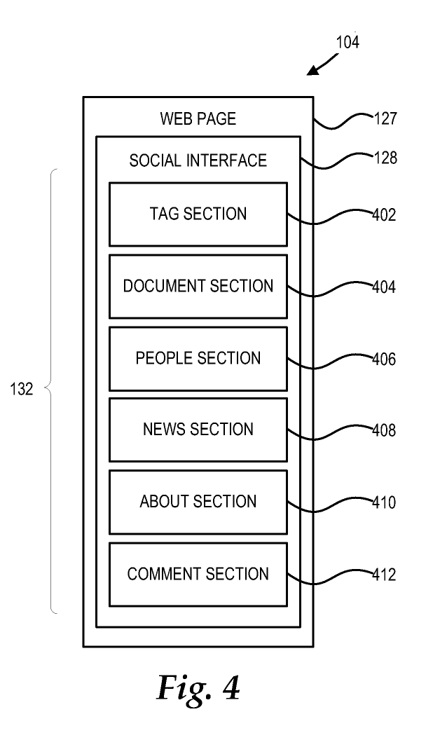

FIG. 4 illustrates a more detailed block diagram for the social interface 128. In the illustrated embodiment shown in FIG. 4, the web page 127 may provide the social interface 128 with the tag profile interface 132. The tag profile interface 132 may further include a tag section 402, a document section 404, a people section 406, a news section 408, an about section 410, and a comment section 412. The tag profile interface 130 may retrieve information for theses sections from the user profile database 112 and/or the social tagging database 126. Real-time searches across the private computer network 100 may also be used as well.

In one embodiment, the tag profile interface 132 comprises the tag section 402 arranged to present related tags for the selected tag. The tag section 402 may also display an input element to generate a search query and present a search result having documents with the selected tag and one or more related tags. The tag section 402 may enable interactive tag operations to provide a richer query experience so that users can see related tags and use them to create a more specific query, thereby providing a more focused search result for the user.

In one embodiment, the tag profile interface 132 comprises the document section 404 arranged to present documents previously tagged or commented on by the other users. Optional metadata associated with the documents may also be displayed, such as a number of tags for the document, a number of users that applied the same tag, input elements to tag the documents, and so forth. The document section 404 may enable a user to access profile pages for each tag applied to documents and websites across a private computer network.

In one embodiment, the tag profile interface 132 comprises the people section 406 arranged to present users with expertise or interest in tracking documents associated with the selected tag. The people section 406 may further present input elements to designate a user as an expert or having interest in the selected tag. The people section 406 may provide a listing of experts and people interested in the topic, and allow a user to designate their particular expertise and interest in the selected tag. This allows the viewer to initiate social networking activities with the individuals listed in the people section 406, or to monitor activities for the individuals to find relevant content for the viewer.

In one embodiment, the tag profile interface 132 comprises the news section 408 arranged to present a news feed of recent activities associated with the selected tag. The news feed may allow a user to differentiate between relatively popular or hot topics, versus those tags used for aging or unpopular topics. It also allows the viewer to get quickly assess and explore recent items of interest.

In one embodiment, the tag profile interface 132 comprises the about section 410 arranged to present descriptive information associated with the selected tag, synonyms associated with the selected tag, and alternative tags associated with the selected tag. The about section 410 calls into managed taxonomy features offered by the private computer network 100. The about section 410 provides information about a selected tag, thereby allowing a user to understand a context for the selected tag, and whether the selected tag is appropriate as a search term or tag for a particular document. This may lead to more effective use of the selected tag.

In one embodiment, the tag profile interface 132 comprises the comment section 412 arranged to provide a text dialog box enabling the user to enter a comment regarding the selected tag or other sections presented by the tag profile interface, and present previous comments regarding the selected tag or other sections presented by the tag profile interface. The comment section 412 provides a discussion area so that users may interact and discuss a selected tag, documents for the selected tag, and other topics relevant to users and the selected tag.

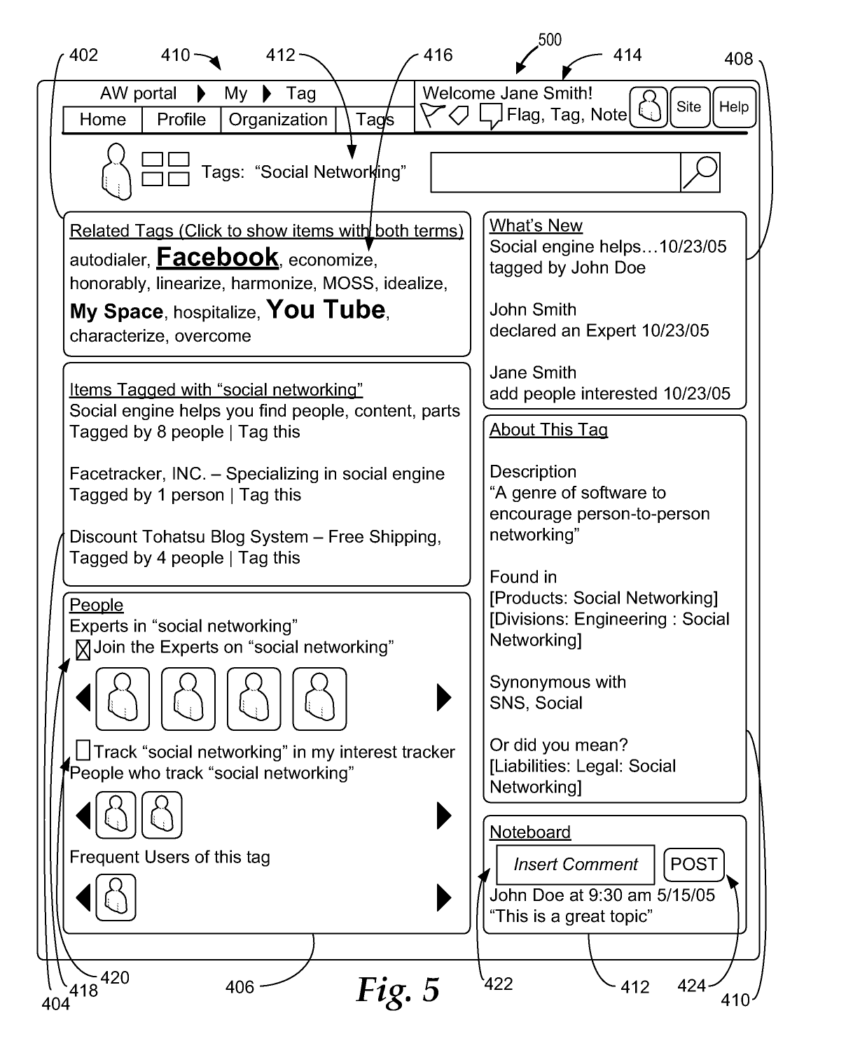

FIG. 5 is a screen display diagram showing an illustrative screen display 500 provided by the web browser 110 in various embodiments presented herein. In particular, FIG. 5 shows an illustrative implementation of the tag profile interface 132 of the social interface 128. It should be appreciated that other interface elements may be utilized to represent the social interface 128 as contemplated by those skilled in the art.

In the illustrated embodiment shown in FIG. 5, the screen display 500 illustrates an exemplary implementation of a web page 127 including a tag profile interface 132 for a selected tag 492 given the keywords “Social Networking.” The screen display 500 includes a social menu provided by the about section 410, with various tabs for a user portal for a user 414 named “Jane Smith,” such as a portal implemented using MICROSOFT SHAREPOINT® technologies.

The screen display 500 illustrates the tag section 402 titled “Related Tags” and a list of tags related to the selected tag 492. For instance, the selected tag 492 comprising “social networking” may have related tags such as “Facebook” and “My Space,” which are well known social networking web sites. Each related tag may comprise a hyperlink which when activated may generate a search query with the selected tag 492 and the selected related tag, such as the selected related tag 416 given the keyword “economize.” The tag profile interface 132 may use the tags 412, 416 to perform a narrower and more focused search using the combined tags 412, 416, thereby delivering more focused search results and shared information from the private computer network 100.

The screen display 500 may further illustrate the document section 404 titled “Items Tagged with ‘social networking.’” As with the person profile interface 130, the tag profile interface 132 may search the private computer network 100 for documents having been previously tagged with the selected tag 492. The tagged documents may include those documents tagged by the user 414 viewing the screen display 500, as well as documents tagged by other users of the private computer network 100. The document section 404 may also display various metadata for the tagged/commented documents, such as metadata information indicating a number of people that have tagged a document. The document section 404 may further present an input element for the user 414 to also tag the document thereby increasing the number of people having tagged the document. The number of people that have tagged a document may be loosely correlated with accuracy in tagging operations, thereby allowing the user 414 to have increased comfort that the document has subject matter actually relevant to the selected tag 492.

The screen display 500 may also illustrate the people section 406 titled “People.” The people section 406 may provide information about users of the private computer network 100 that have used the selected tag 492, monitor the selected tag 492, or otherwise have some level of interest in the selected tag 492. The people section 406 may provide, for example, pictures and identifying information (e.g., name, title, location, etc.) for users that have been designated as experts (by themselves or others) in the topic related to the selected tag 492. An input element 418 may allow the user 414 to designate herself as an expert in a topic related to the selected tag 492. An input element 420 may allow the user 414 to indicate that she is interested in the selected tag 492, and to add the selected tag 492 to her interest tracker stored as part of the user profile database 112.

The screen display 500 may further illustrate the news section 408 titled “What's New.” The news section 408 may contain recent activities related to the selected tag 492. For instance, the news section 408 may present recent documents tagged with the selected tag 492, users designated as experts in topics related to the selected tag 492, users tracking topics related to the selected tag 492, and so forth.

The screen display 500 may illustrate the about section 410 titled “About This Tag.” The about section 410 may provide descriptive information about the selected tag 492, hierarchical information indicating where the selected tag 492 falls within a managed taxonomy for the private computer network 100, synonymous tags for the selected tag 492, and alternative tags (or tag hierarchies) for the selected tag 492.

The screen display 500 may illustrate the comment section 412 titled “Noteboard.” The comment section 412 may include a text dialog box 422 enabling the user 414 to enter a comment regarding the selected tag 492 or other sections presented by the tag profile interface 132. The comment section 412 may also present previous comments regarding the selected tag 492 or other sections presented by the tag profile interface 132. The user 414 may use the input element 424 labeled “POST” to enter the comment, where it will then subsequently appear in the comment section 412.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

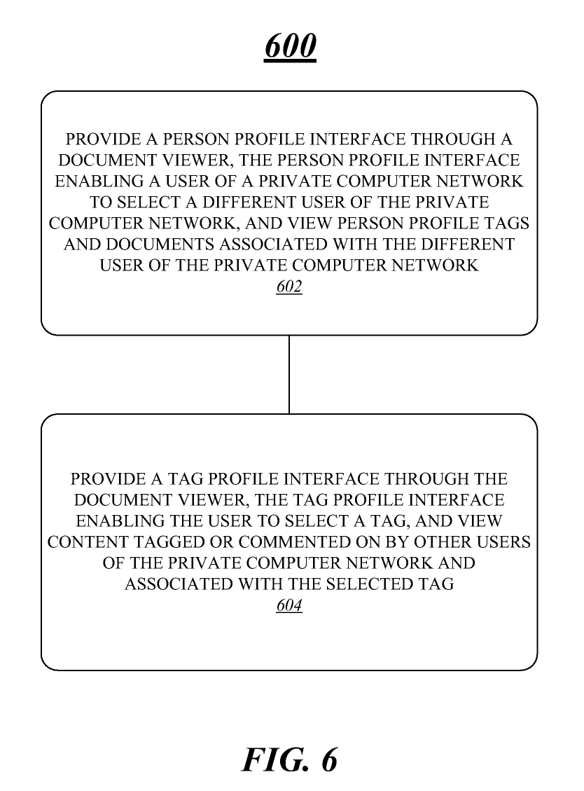

FIG. 6 illustrates one embodiment of a logic flow 600. The logic flow 600 may be representative of some or all of the operations executed by one or more embodiments described herein.

In the illustrated embodiment shown in FIG. 6, the logic flow 600 may provide a person profile interface through a document viewer, the person profile interface enabling a user of a private computer network to select a different user of the private computer network, and present person profile tags and documents associated with the different user of the private computer network at block 602. For example, the person profile interface 130 may enable a user of the private computer network 100 to select the user or a different user of the private computer network 100, and present person profile tags and documents associated with the user or the different user of the private computer network 100. The embodiments are not limited in this context.

The logic flow 600 may provide a tag profile interface through the document viewer, the tag profile interface enabling the user to select a tag, and present content tagged or commented on by other users of the private computer network and associated with the selected tag at block 604. For example, the tag profile interface 132 enables a user to select a tag, such as the selected tag 492, and present content tagged or commented on by other users of the private computer network 100 and associated with the selected tag. The embodiments are not limited in this context.

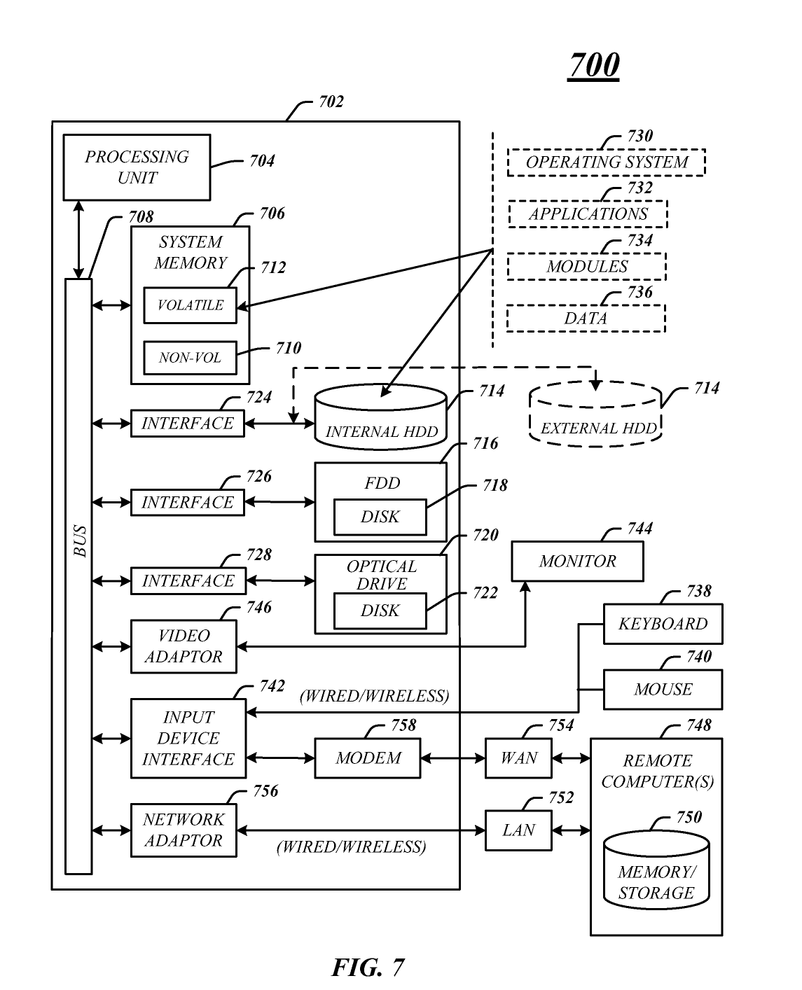

FIG. 7 illustrates an embodiment of an exemplary computing architecture 700 suitable for implementing various embodiments as previously described with reference to FIGS. 1-6. The computing architecture 700 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors. Dual microprocessors and other multi-processor architectures may also be employed as the processing unit 704. The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures.

The system memory 706 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media, including an internal hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. The one or more application programs 732, other program modules 734, and program data 736 can include, for example, the interfaces 128, 130 and 132.

A user can enter commands and information into the computer 702 through one or more wire/wireless input devices, for example, a keyboard 738 and a pointing device, such as a mouse 740. Other input devices may include a microphone, an infra-red (IR) remote control, a joystick, a game pad, a stylus pen, touch screen, or the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
providing a person profile interface through a document viewer, the person profile interface enabling a user of a private computer network to select a different user of the private computer network, and present person profile tags and documents associated with the different user of the private computer network; and
providing a tag profile interface through the document viewer, the tag profile interface enabling the user to select a tag, and present content tagged or commented on by other users of the private computer network and associated with the selected tag.

2. The method of claim 1, wherein the tags comprise an arbitrary tag created by the user or a managed tag created by an organization and selected by the user.

3. The method of claim 1, wherein the document viewer comprises a web browser and the document comprises a web page.

4. The method of claim 1, wherein the person profile interface and the tag profile interface are provided independent of functionality provided by the document.

5. The method of claim 1, wherein the person profile interface and the tag profile interface are provided by altering the document to include the person profile interface and the tag interface.

6. The method of claim 1, wherein the person profile interface and the tag profile interface are provided by the document viewer via a document viewer plug-in.

7. The method of claim 1, wherein the person profile interface comprises a first section to present the person profile tags and a second section to present documents having been previously tagged or commented on by the different user.

8. The method of claim 1, wherein the tag profile interface comprises a first section to present related tags for the selected tag, and an input element to generate a search query and present a search result having documents with the selected tag and a related tag.

9. The method of claim 1, wherein the tag profile interface comprises a second section to present documents previously tagged or commented on by the other users.

10. The method of claim 1, wherein the tag profile interface comprises a third section to present users with expertise or interest in tracking documents associated with the selected tag, and input elements to designate the user as an expert or having interest in the selected tag.

11. The method of claim 1, wherein the tag profile interface comprises a fourth section to present a news feed of recent activities associated with the selected tag.

12. The method of claim 1, wherein the tag profile interface comprises a fifth section to present descriptive information associated with the selected tag, synonyms associated with the selected tag, and alternative tags associated with the selected tag.

13. The method of claim 1, wherein the tag profile interface comprises a sixth section comprising a text dialog box enabling the user to enter a comment regarding the selected tag or other sections presented by the tag profile interface, and present previous comments regarding the selected tag or other sections presented by the tag profile interface.

14. A method, comprising:
providing a person profile interface in a hypertext markup language (HTML) frame of a web page, the person profile interface enabling a user of an intranet to select a different user of the intranet, and present person profile tags and documents associated with the different user of the intranet as the web page is displayed by a web browser; and
providing a tag profile interface in the HTML frame of the web page, the tag profile interface enabling the user of the intranet to select a tag from a managed taxonomy, and present content tagged or commented on by other users of the intranet and associated with the selected tag from the managed taxonomy as the web page is displayed by the web browser.

15. The method of claim 13, comprising providing a social menu, the social menu comprising a button for accessing the person profile interface and the tag profile interface.

16. The method of claim 13, comprising providing a web page with an input element for the person profile interface and the tag profile interface.

17. A computer-readable medium having computer-executable instructions stored thereon which, when executed by a computer, cause the computer to:
provide a person profile interface within a document, the person profile interface adapted to receive a selection for a user, and display person profile tags and documents associated with the user; and
provide a tag profile interface within the document, the tag profile interface adapted to receive a selection for a tag, and display content tagged or commented on by users of a computer network and associated with the selected tag.

18. The computer-readable medium of claim 17 having computer-executable instructions stored thereon which, when executed by a computer, cause the computer to display the person profile tags as a tag cloud, with some of the person profile tags having visual effects to enhance viewing of the person profile tags.

19. The computer-readable medium of claim 17 having computer-executable instructions stored thereon which, when executed by a computer, cause the computer to display the person profile tags and documents having been previously tagged or commented on by the different user.

20. The computer-readable medium of claim 17 having computer-executable instructions stored thereon which, when executed by a computer, cause the computer to display related tags for the selected tag, documents previously tagged or commented on by the other users, users with expertise or interest in tracking documents associated with the selected tag, a news feed of recent activities associated with the selected tag, descriptive information associated with the selected tag, synonyms associated with the selected tag, and alternative tags associated with the selected tag, and comments regarding the selected tag or other information displayed by the tag profile interface.
